(19) United States
(12) Patent Application Publication
(10) Pub. No.: US 2014/0297110 A1
(43) Pub. Date: Oct. 2, 2014

(54) IN-VEHICLE RELAY APPARATUS AND COMMUNICATION SYSTEM

(71) Applicants: AUTONETWORKS TECHNOLOGIES, LTD, Yokkaichi (JP); SUMITOMO ELECTRIC INDUSTRIES, LTD., Osaka (JP); SUMITOMO WIRING SYSTEMS, LTD., Yokkaichi (JP)

(72) Inventors: Tetsuya NODA, Yokkaichi (JP); Hiroshi OKADA, Yokkaichi (JP)

(73) Assignees: AUTONETWORKS TECHNOLOGIES, LTD, Yokkaichi (JP); SUMITOMO ELECTRIC INDUSTRIES, LTD., Osaka (JP); SUMITOMO WIRING SYSTEMS, LTD., Yokkaichi (JP)

(21) Appl. No.: 14/227,297

(22) Filed: Mar. 27, 2014

(30) Foreign Application Priority Data
Mar. 28, 2013 (JP) 2013-070221

(51) Int. Cl. B60R 16/023

(52) U.S. Cl. CPC B60R 16/023
USPC 701/36

(57) ABSTRACT

An in-vehicle relay apparatus can restrict transmission of identification information with which a vehicle can be specified to the outside of the vehicle. A vehicle internal communication unit may communicate with at least one in-vehicle device installed in a vehicle, and a vehicle external communication unit may communicate with a vehicle external communication device disposed outside of the vehicle. A communication processing unit may add identification information to relay information that is transmitted to the vehicle external communication device. The identification information may regard a transmission source of relay information by which the vehicle external communication device determines the transmission source of the relay information. Additionally, the communication processing unit may transmit, using the vehicle external communication device, the relay information to the vehicle external communication device. A determination unit may determine which information is used as the identification information based on stored access authority levels.

### TECHNICAL FIELD

The present disclosure relates to an in-vehicle relay apparatus and a communication system that relays communication between in-vehicle devices installed in a vehicle and a vehicle external communication device disposed externally.

### BACKGROUND

JP 2010-183261 A discloses a communication system for performing communication between a communication apparatus installed in a moving object (referred to below as “moving object side communication apparatus”) and a roadside communication apparatus. The moving object side communication apparatus receives identification information of the roadside communication apparatus itself or a constituent component thereof, and creates transmission source information to be added to data that is to be transmitted to the roadside communication apparatus. The moving object side communication apparatus encrypts the data that is necessary for creating of the transmission source information based on the identification information received from the roadside communication apparatus. The moving object side communication apparatus adds the transmission source information to the encrypted data, and transmits the data to the roadside communication apparatus.

With the above-described communication system, which performs communication between road and vehicle, a traffic center or the like, for example, collects information from vehicles so as to recognize the state of traffic jams, the weather, etc. in various regions, and feeds back the information to the vehicles, thereby making it possible for the drivers of the vehicles to realize comfortable driving. Furthermore, the police or the like, for example, may collect information on vehicles and can realize searches for stolen cars, lost cars, or the like.

JP 2010-183261A is an example of related art.

### SUMMARY

However, there may be a case where information leak occurs in a traffic center or the like that collects information on vehicles. For example, the driving history or the like of a vehicle can easily be determined by collecting vehicle-specific identification information and vehicle position information, and these types of information are information relating to the privacy of the user of the vehicle. Therefore, it is preferable not to transmit information with which a vehicle can be specified. On the other hands, in order for the police or the like to conduct a search for a stolen car, a lost car, or the like, it is necessary to collect information with which vehicles can be specified.

The present device, and variations thereof, were made in view of the above-described circumstances, and an object of the present disclosure is to provide an in-vehicle relay apparatus and a communication system that can restrict transmission of identification information with which a vehicle can be specified to the outside of the vehicle.

An in-vehicle relay apparatus according to one aspect of the present disclosure is directed to an in-vehicle relay apparatus for relaying communication between an in-vehicle device installed in a vehicle and a vehicle external communication device disposed outside of the vehicle, the in-vehicle relay apparatus including:

a vehicle internal communication unit configured to communicate with at least one in-vehicle device installed in a vehicle; a vehicle external communication unit configured to communicate with the vehicle external communication device; a communication processing means unit configured to (1) add identification information to relay information to be transmitted to the vehicle external communication device, the identification information regarding a transmission source of relay information by which the vehicle external communication device can determine the transmission source of the relay information and to (2) transmit, using the vehicle external communication unit, the relay information, to which the identification information is added, to the vehicle external communication device; an acquiring unit configured to acquire first information stored in a storage unit; a creation unit configured to create second information that is different from the first information; and a determination unit configured to determine which of the first information and the second information the communication processing unit is to use as the identification information, wherein the communication processing unit is further configured to transmit the relay information to the vehicle external communication device using as the identification information either the first information or the second information depending on a result of the determination by the determination unit.

Furthermore, the in-vehicle relay apparatus according to another aspect of the present disclosure further includes a discard determination unit configured to determine, after having communicated with the vehicle external communication device using the second information created by the creation unit, whether to discard the second information based on whether a predetermined condition is satisfied, wherein, if the discard determination unit determines that the second information is to be discarded, the second information is discarded.

The in-vehicle relay apparatus according to another aspect of the present disclosure is such that the predetermined condition includes information: (i) that communication between the vehicle external communication device and the vehicle external communication unit is terminated, (ii) that communication between the vehicle external communication device and the vehicle external communication unit has not been performed for a predetermined period of time, (iii) that a predetermined period of time has elapsed since the creation unit created the second information, (iv) that a request is given from the vehicle external communication device, or (v) that a switch for starting a motor of the vehicle is switched to a predetermined state.

Furthermore, the in-vehicle relay apparatus according to another aspect of the present disclosure further includes: a program storage unit that stores at least one information transmission processing program that executes processing for transmitting, to the vehicle external communication device, information that the vehicle internal communication unit has received from the at least one in-vehicle device; a processing unit configured to execute the information transmission processing program stored in the program storage unit; and an access authority level storage unit that stores an access authority level for each information transmission processing program, wherein the determination unit is configured to perform the determination based on the access authority level stored in the access authority level storage unit.

Furthermore, the in-vehicle relay apparatus according to another aspect of the present disclosure is such that the determination unit is configured to determine that communication with the vehicle external communication device by a said information transmission processing program has a low access authority level using the second information created by the creation unit, and determine that communication with the vehicle external communication device by a said information transmission processing program has a high access authority level using the first information.

Furthermore, the in-vehicle relay apparatus according to another aspect of the present disclosure is such that the access authority level is based on a transmission destination to which the information transmission processing program transmits information.

Furthermore, the in-vehicle relay apparatus according to another aspect of the present disclosure is such that the first information is information that is specific to the vehicle.

Furthermore, the in-vehicle relay apparatus according to another aspect of the present disclosure is such that the creation unit is configured to create the second information using a random number.

A communication system according to another aspect of the present disclosure is directed to a communication system including: at least one in-vehicle device installed in a vehicle; a vehicle external communication device disposed outside of the vehicle; and an in-vehicle relay apparatus that relays communication between the at least one in-vehicle device and the vehicle external communication device, the in-vehicle relay apparatus including: a vehicle internal communication unit that communicates with the at least one in-vehicle device; a vehicle external communication unit that communicates with the vehicle external communication device; a communication processing unit configured to (1) add identification information to relay information to be transmitted to the vehicle external communication device, the identification information regarding a transmission source of relay information by which the vehicle external communication device can determine the transmission source of the relay information and to (2) transmit, using the vehicle external communication unit, the relay information, to which the identification information is added, to the vehicle external communication device; an acquiring unit configured to acquire first information stored in a storage unit; a creation unit configured to create second information that is different from the first information; and a determination unit configured to determine which of the first information and the second information the communication processing unit is to use as the identification information, wherein the communication processing unit is configured to transmit the relay information to the vehicle external communication device using as the identification information either the first information means or the second information depending on a result of the determination unit.

In the present disclosure, the in-vehicle relay apparatus selects either the first information acquired from the storage unit or the second information created by the in-vehicle relay apparatus based on, for example, a random number or the like, and communicates with the vehicle external communication device using the selected information as identification information. By the in-vehicle relay apparatus selecting, according to the need, identification information for use in communication with the vehicle external communication device, it is possible to restrict transmission of information with which the vehicle can be specified to the outside of the vehicle.

Furthermore, according to another aspect of the present disclosure, after having performed communication with the vehicle external communication device using the created second information as identification information, the in-vehicle relay apparatus discards the created second information if a predetermined condition is satisfied. If a need to communicate with the vehicle external communication device occurs afterward, the in-vehicle relay apparatus can newly create the second information. Accordingly, different identification information will be used each time communication with the vehicle external communication device is performed.

Examples of the predetermined condition for determining whether or not to discard the second information include at least one of the following conditions in which:
the communication between the in-vehicle relay apparatus and the vehicle external communication device is terminated. Here, “communication” may mean, for example, that data transmission/reception between the in-vehicle relay apparatus and the vehicle external communication device is performed once, or that data transmission/reception that is necessary for given processing is performed multiple times;
communication between the in-vehicle relay apparatus and the vehicle external communication device has not been performed for a predetermined period of time. The predetermined period of time may be, for example, several minutes, several tens of minutes, several hours, or the like. The reason why the communication has not been performed is considered that, for example, the vehicle is driving outside of the communication range, that processing does not need to perform communication, or other reason;
a predetermined period of time has elapsed since the in-vehicle relay apparatus created the second information. The predetermined period of time may be, for example, several minutes, several tens of minutes, several hours, or the like;
a request to terminate the communication, to update the second information, or the like is given from the vehicle external communication device to the in-vehicle relay apparatus; and
a switch, that is, a so-called ignition switch for starting the motor of the vehicle is switched to a predetermined state (e.g., an off state or the like).

Furthermore, according to another aspect of the present disclosure, the in-vehicle relay apparatus transmits information from the in-vehicle device to the vehicle external communication device by the processing unit executing an information transmission processing program. An access authority level is set for each information transmission processing program, and based on this level, it is determined which of the first information and the second information is used as identification information to perform communication with the vehicle external communication device. Accordingly, by appropriately setting an access authority level depending on, for example, a destination of communication by an information transmission processing program, it is possible to appropriately determine which information is used as identification information.

For example, it is configured such that the second information created by the in-vehicle relay apparatus is used for communication with the vehicle external communication device by an information transmission processing program having a low access authority level, and the first information is used for the communication with the vehicle external communication device by an information transmission processing program having a higher access authority level.

According to another aspect of the present disclosure, the in-vehicle relay apparatus is configured to communicate with the vehicle external communication device using either the first information acquired from the storage unit or the created second information as identification information, thereby making it possible to restrict transmission of information with which the vehicle can be specified to the outside of the vehicle. Therefore, it is possible to reduce the possibility that information relating to the privacy of the user of the vehicle, or the like leaks.

### BRIEF DESCRIPTION OF THE DRAWINGS

FIG. 1 is a schematic diagram illustrating a configuration of a communication system according to an embodiment.

FIG. 2 is a block diagram illustrating a configuration of a security controller.

FIG. 3 is a schematic diagram illustrating an example of a configuration of an access authority level table.

FIG. 4 is a schematic diagram illustrating an example of a configuration of an access permission level table.

FIG. 5 is a flowchart illustrating a procedure of an information transmission process by the security controller.

FIG. 6 is a flowchart illustrating a procedure of an information transmission process by the security controller.

### DETAILED DESCRIPTION OF EMBODIMENTS

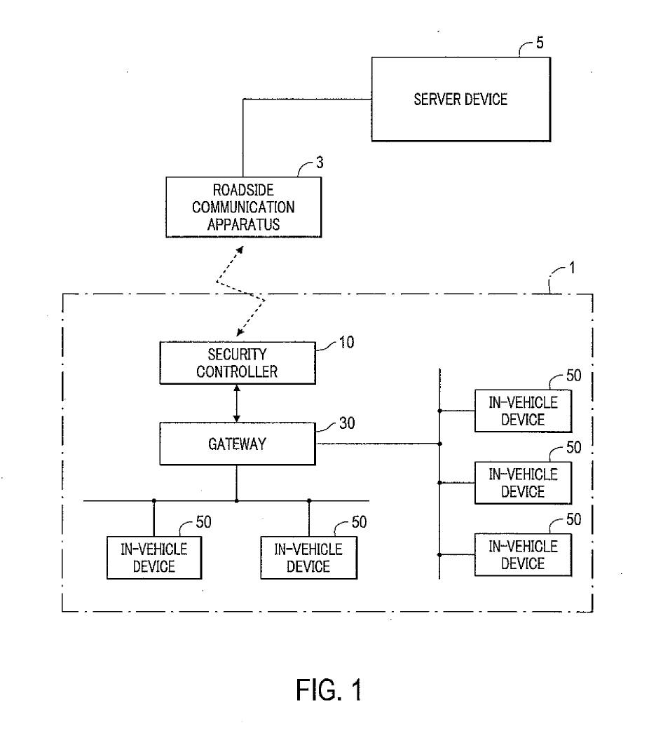

Various embodiments will be specifically described with reference to the drawings. FIG. 1 is a schematic diagram illustrating a configuration of a communication system according to one embodiment. In the drawing, the reference numeral 1 indicated by the alternate long and short dash line denotes a vehicle, and the vehicle 1 includes a security controller 10, a gateway 30, and a plurality of in-vehicle devices 50, for example. In the vehicle 1, there are a plurality of communication groups each constituted by a plurality of in-vehicle devices 50 that are connected in a bus arrangement to a common communication line, and the gateway 30 relays communication between the communication groups. Therefore, the multiple communication lines are connected to the gateway 30. Furthermore, the gateway 30 is connected to the security controller 10, and transmits information from the security controller 10 to the in-vehicle devices 50, and provides information received from the in-vehicle devices 50 to the security controller 10.

The security controller 10 has the function to relay communication between a roadside communication apparatus 3 disposed outside of the vehicle 1, and an in-vehicle network of the vehicle 1 that includes the gateway 30 and the in-vehicle device 50, for example, and is connected to the gateway 30. The roadside communication apparatus 3 may be installed on, for example, an intersection or the like of a main road, and can transmit and receive information to and from the vehicle 1 by wireless communication using radio waves, light, or the like. Furthermore, the roadside communication apparatus 3 may be connected to a server device 5 via a dedicated communication network, for example the Internet, or the like, and may relay transmission and reception of information between the vehicle 1 and the server device 5.

The server device 5 may be disposed in an appropriate place outside of the vehicle 1, and communicates with the vehicle 1 via the roadside communication apparatus 3. The server device 5 may be, for example, an apparatus, installed in a traffic center, for managing traffic jam information. In this case, the server device 5 collects vehicle speed information, position information, and the like that are transmitted from the vehicle 1 so as to determine whether or not there is a traffic jam, or the like, and feeds back the traffic jam information to the vehicle 1. Furthermore, the server device 5 may be, for example, an apparatus with which the police may determine the vehicle position. In this case, the server device 5 collects vehicle-specific identification information, position information on the vehicle 1, and the like that are transmitted from the vehicle 1, and performs processing for identifying the specific position of the vehicle 1. Note that the server device 5 may be any suitable apparatus for performing various types of processing other than the above-described apparatuses.

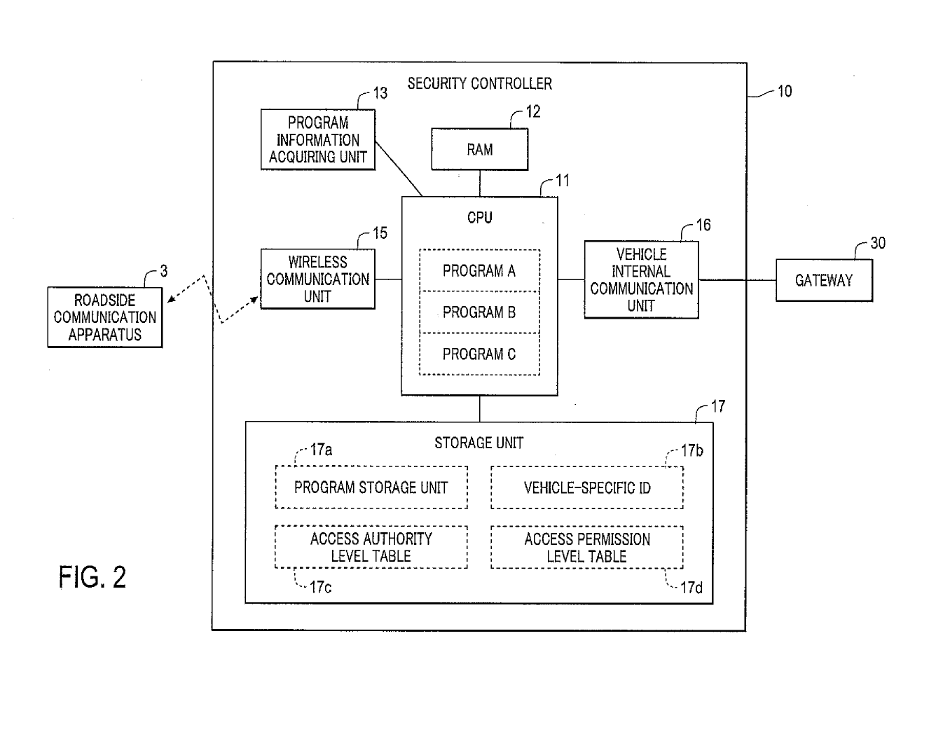

FIG. 2 is a block diagram illustrating a configuration of the security controller 10. The security controller 10 includes a Central Processing Unit (CPU) 11, a Random Access Memory (RAM) 12, a position information acquiring unit 13, a wireless communication unit 15, a vehicle internal communication unit 16, and a storage unit 17, for example. The CPU 11 is an arithmetic processing unit that performs various types of processing by reading one or more programs stored in a program storage unit 17a of the storage unit 17 into the RAM 12, and executing the read program. In the illustrated example, the CPU 11 executes three programs A to C. The CPU 11 can execute a plurality of programs in parallel while switching them in a time-division manner or the like, for example. Furthermore, in some embodiments, programs that are executed by the CPU 11 may include a program that performs processing for obtaining information on the vehicle 1 from the in-vehicle device 50, and transmitting the vehicle information to a specific server device 5 via the roadside communication apparatus 3.

The RAM 12 is constituted by a memory element such as a static RAM (SRAM), a dynamic RAM (DRAM), or the like, and temporarily stores a program executed by the CPU 11, data needed for the execution, and the like. The position information acquiring unit 13 may acquire position information on the vehicle 1, and may provide the acquired position information to the CPU 11. The position information acquiring unit 13, to which an antenna or the like for receiving a signal of, for example, a Global Positioning System (GPS) is connected, may be configured to calculate the position (such as latitude and longitude) of the vehicle 1 based on the received signal. Furthermore, the position information acquiring unit 13 may calculate the position of the vehicle 1 with the use of information obtained from a sensor, such as a speed sensor, an acceleration sensor, or a gyro sensor, as well as map information, for example. If a car navigation device is installed in the vehicle 1, a configuration is also possible in which the ear navigation device performs processing for calculating the position of the vehicle 1, and the security controller 10 obtains and uses the calculated result.

The wireless communication unit 15 may perform wireless communication with the roadside communication apparatus 3 installed outside of the vehicle 1 with the use of wireless signals such as radio waves, light, or the like. The wireless communication unit 15 transmits information provided from the CPU 11 to the roadside communication apparatus 3, and provides information received from the roadside communication apparatus 3 to the CPU 11. The vehicle internal communication unit 16 is connected to the gateway 30 installed in the vehicle 1 via a communication cable. The vehicle internal communication unit 16 communicates with the gateway 30 complying with a standard such as the Controller Area Network (CAN) or Local Interconnect Network (LIN), for example. The vehicle internal communication unit 16 transmits information provided from the CPU 11 to the gateway 30, and provides information received from the gateway 30 to the CPU 11.

The storage unit 17 may be constituted by a non-volatile memory element such as a flash memory or an Electrically Erasable Programmable Read Only Memory (EEPROM), a magnetic storage device such as a hard disk, or the like. The storage unit 17 includes a program storage unit 17a in which programs to be executed by the CPU 11, data needed for the execution, and the like are stored. The storage unit 17 also stored a vehicle-specific ID 17b, an access authority level table 17c, an access permission level table 17d, and the like.

The vehicle-specific ID 17b may be information that is uniquely assigned to the vehicle 1. A different piece of information serving as the vehicle-specific ID 17b is assigned to each vehicle 1, and there are not two vehicles 1 that have the same information. Note that the vehicle-specific ID 17b is not necessarily stored in the storage unit 17 of the security controller 10. For example, the vehicle-specific ID 17b may be stored in the gateway 30, an in-vehicle device 50, or the like, and the security controller 10 may obtain the vehicle-specific ID 17b from this component via the in-vehicle network.

In the communication system according to some embodiments, an ID (identification information) is given to information to be transmitted to the server device 5 from the vehicle 1 via the roadside communication apparatus 3, in order to allow the server device 5 to specify a communication partner. The security controller 10 according to some embodiments has the function to create a provisional ID based on a random number for example. The security controller 10 selects either the created provisional ID or the vehicle-specific ID 17b stored in the storage unit 17, depending on, for example, the type of the server device 5 serving as a communication partner, and communicates with the server device 5 using the selected ID. At that time, the security controller 10 determines which of the provisional ID and the vehicle-specific ID 17b is used for performing communication, based on the access authority level table 17c stored in the storage unit 17.

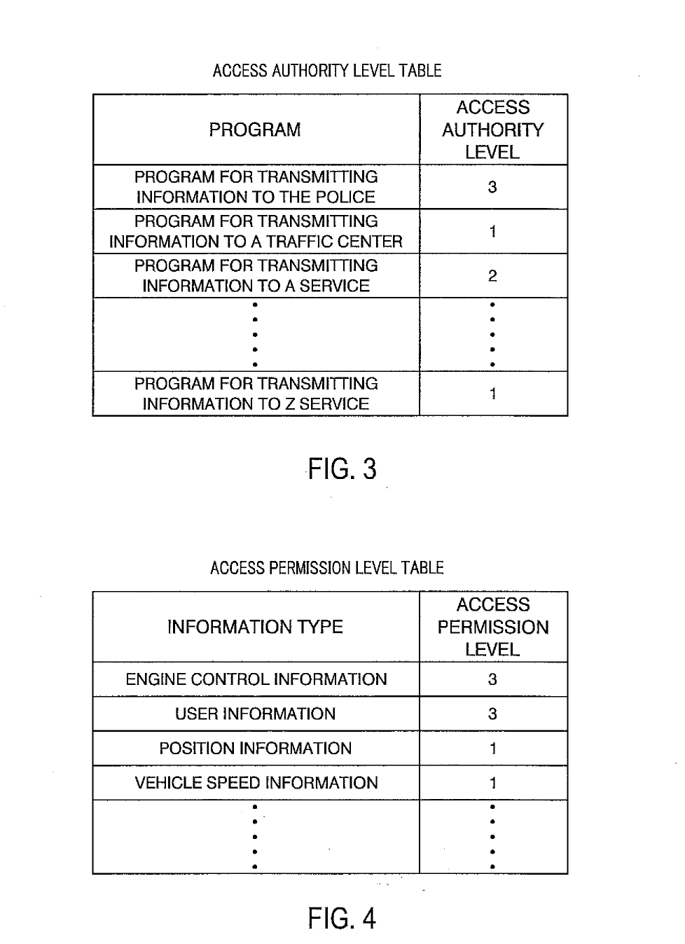

FIG. 3 is a schematic diagram illustrating an example of a configuration of the access authority level table 17c. The access authority level table 17c has stored therein access authority levels in association with programs stored in the program storage unit 17a of the storage unit 17. In the illustrated example, programs with names, explanations, and the like, such as a program for transmitting information to the police and a program for transmitting information to a traffic center, are shown as programs, but they are just examples, and any type of information may be used as long as it is information with which the programs can be identified.

Also, three levels 1 to 3 are set as access authority levels of the access authority level table 17c. However, this is just an example, and there may also be two or four or more access authority levels. The larger the numerical value of the access authority level, the higher access authority it has. That is, a program having the access authority level 3 can access more information than a program having the access authority level 1 or 2. In the illustrated example, the highest access authority level 3 is set for the program for transmitting information to the police. On the other hand, the lowest access authority level 1 is set for the program for transmitting information to a traffic center. Note that although, in the illustrated example, the access authority levels are expressed by numerical values, this is just an example and any type of information may be used as long as it is information with which the order of priority can be identified.

The access authority level table 17c may be configured such that, for example, if a program is installed in the storage unit 17 of the security controller 10, the security controller 10 registers the program in the access authority level table 17c. In this case, the security controller 10 can determine, for example, a distribution source of the program based on information such as a digital signature, decide an access authority level based on e.g. the reliability of the distribution source, and register the access authority level of the installed program in the access authority level table 17c. Furthermore, a configuration is also possible in which a dealer, a manufacturer, or the like of the vehicle 1 creates the access authority level table 17c, and provides the created access authority level table 17c to the security controller 10. In this case, it is also possible that the security controller 10 accesses a server device of the dealer, the manufacturer, or the like of the vehicle 1 so as to obtain the access authority level table 17c. Furthermore, a configuration is also possible in which the security controller 10 is connected to a dedicated information updating apparatus or the like at a dealer, a maintenance facility, or the like of the vehicle 1, and an operator of the dealer, the maintenance facility, or the like performs registration, updating, or the like of the access authority level table 17c.

Although any method may be used for setting the access authority level table 17c and storing it in the storage unit 17 of the security controller 10, it may be necessary that an appropriate access authority level be set for each program. In some embodiments, the access authority level of a program for transmitting information to the server device 5 via the roadside communication apparatus 3 is set depending on the transmission destination of this information.

In a case where an information transmission program having the access authority level 3 transmits information to the server device 5, the security controller 10 according to some embodiments performs communication using the vehicle-specific ID 17b stored in the storage unit 17. On the other hand, in a case where an information transmission program having the access authority level 1 or 2 transmits information to the server device 5, the security controller 10 performs communication temporarily using the provisional ID created by the security controller 10 itself.

Furthermore, the security controller 10 may have stored in an access permission level table 17d, as access permission levels, access authority levels with which programs are permitted to access the various information that is transmitted and received in the in-vehicle network of the vehicle 1 (that is, the various information that the vehicle internal communication unit 16 transmits and receives). FIG. 4 is a schematic diagram illustrating an example of a configuration of the access permission level table 17d. The access permission level table 17d has stored therein access permission levels in association with types of information that are transmitted and received. In the illustrated example, engine control information, user information, position information, vehicle speed information, and the like are shown as examples of types of information of the access permission level table 17d. These types of information can be determined based on the ID number added to a frame that is transmitted or received, the stored order of information in the frame, or the like if the in-vehicle network complies with, for example, the CAN standard.

Also, three levels 1 to 3 are set as access permission levels of the access permission level table 17d. However, this is just an example, and there may also be two or four or more access permission levels. The larger the numerical value of the access permission level, the higher the access authority level needed for accessing the information is. That is, information having the access permission level 3 can be accessed by a program having the access authority level 3 or higher. Also, information having the access permission level 1 can be accessed by a program having the access authority level 1 or higher. In the illustrated example, the engine control information and the user information are set to have the access permission level 3, and the position information and the vehicle speed information are set to have the access permission level 1. Note that although the access permission levels are expressed with numerical values in the illustrated example, this is just an example and any type of information may be used as long as it is information with which the order of priority can be identified.

If a request to access information of the in-vehicle network is given through execution of a program, the CPU 11 of the security controller 10 checks the access authority level of this program and the access permission level of the information to which the access is requested. If the access authority level of the program is at least the access permission level of the information, the CPU 11 permits this program to access the information. That is, the CPU 11 acquires the information to which the access is requested from reception information of the vehicle internal communication unit 16, and uses the acquired information for the processing of this program. On the other hand, if the access authority level of the program is lower than the access permission level of the information, the CPU 11 does not permit this program to access the information. The processing that is performed when the access is not permitted depends on each program.

Similarly, if a request to transmit information to the in-vehicle network is given through execution of a program, the CPU 11 of the security controller 10 checks the access authority level of this program and the access permission level of the information to be transmitted. If the access authority level of the program is at least the access permission level of the information, the CPU 11 permits transmission of the information by this program, and the program transmits the information to the in-vehicle network from the vehicle internal communication unit 16. On the other hand, if the access authority level of the program is lower than the access permission level of the information, the CPU 11 does not permit transmission of the information by this program.

Accordingly, if the CPU 11 of the security controller 10 executes a program that transmits information to the server device 5, the types of the information to be transmitted to the server device 5 by this program are restricted, depending on the access authority level of the information transmission program and the access permission level of the information to be transmitted.

In the communication system according to some embodiments, if a request to transmit information is given to the vehicle 1 from the roadside communication apparatus 3 that is disposed outside of the vehicle during driving of the vehicle 1 for example, communication between the server device 5 and the security controller 10 via the roadside communication apparatus 3 is started. The security controller 10 determines the server device 5 serving as a communication partner based on the information received from the roadside communication apparatus 3, and executes, with the CPU 11, the information transmission program that corresponds to the communication partner. The security controller 10 determines which of the vehicle-specific ID 17b and the provisional ID is used for performing the communication based on the access authority level of the information transmission program.

If, for example, the server device 5 serving as a communication partner belongs to a traffic center, the security controller 10 executes a program for transmitting information to a traffic center that is stored in the program storage unit 17a of the storage unit 17. Since the access authority level of the program for transmitting information to a traffic center is level 1, for example as shown in FIG. 3, the security controller 10 creates a provisional ID for communication. The provisional ID may be created based on, for example, information such as the current position (latitude, longitude, or the like) of the vehicle 1, date, time, or the like, or using random numbers, or a combination thereof. The security controller 10 transmits the created provisional ID, registers it in the server device 5, and afterward performs communication using this provisional ID. Also, the server device 5 that has received the provisional ID from the security controller 10 registers this provisional ID as an ID of the communication partner, and identifies the communication partner based on the registered provisional ID in the subsequent communication.

The security controller 10, which has established communication with the server device 5 with the registration of the provisional ID, collects necessary information from the in-vehicle network by processing the program for transmitting information to a traffic center, and transmits the collected information to the server device 5. At that time, the security controller 10 adds the provisional ID registered in the server device 5 to the information to be transmitted, and transmits the information to the server device 5. The information that the security controller 10 can transmit to the server device 5 based on the processing of the program for transmitting information to a traffic center is only information whose access permission level is set to 1 in the access permission level table 17d of FIG. 4.

By the processing of the program for transmitting information to a traffic center, the security controller 10 transmits, for example, the position information and the vehicle speed information of the vehicle 1 to the server device 5 of the traffic center. The server device 5 recognizes, for example, a traffic jam on the road based on the position information and the vehicle speed information collected from various vehicles 1, and transmits traffic jam information to the vehicles 1. The security controller 10 that has received the traffic jam information from the server device 5 via the roadside communication apparatus 3 can transmit the traffic jam information to a car navigation apparatus installed in the vehicle 1, for example, via the gateway 30, and can let the car navigation apparatus display the traffic jam information. Note that the processing for transmitting, to the car navigation apparatus, the traffic jam information received from the server device 5 may be performed by processing the program for transmitting information to a traffic center, or by processing of another program. However, in the case where the traffic jam information is transmitted to the car navigation apparatus by processing the program for transmitting information to a traffic center, it may be necessary that the access permission level of the traffic jam information be set to 1 in the access permission level table 17d.

Thereafter, the security controller 10 communicates with the server device 5 via the roadside communication apparatus 3 using the provisional ID. If any cause for terminating communication occurs, the security controller 10 discards the provisional ID that was used for communication, and afterward does not perform communication using this provisional ID. Examples of causes for terminating communication may include various types of causes such as, for example, that communication with the roadside communication apparatus 3 has not been performed for a predetermined period of time, that a predetermined period of time has elapsed since the provisional ID was created, that a request to terminate communication is given from the server device 5, or that the ignition switch of the vehicle 1 has been switched to off. Note that the conditions for discarding the provisional ID are not limited to the above, and other types of conditions may be used as well.

An effective term of the provisional ID is at a maximum from the start to the stop of the engine of the vehicle 1, and is preferably shorter than this term. However, it is not impossible to use the provisional ID continuously for more than that term.

Furthermore, if, for example, the server device 5 serving as a communication partner belongs to the police, the security controller 10 executes the program for transmitting information to the police that is stored in the program storage unit 17a of the storage unit 17. Since the access authority level of the program for transmitting information to the police is level 3 as shown in FIG. 3, the security controller 10 reads the vehicle-specific ID 17b stored in the storage unit 17. The security controller 10 transmits the read vehicle-specific ID 17b, registers it in the server device, and afterward performs communication using this vehicle-specific ID 17b. The server device 5 that has received the vehicle-specific ID 17b from the security controller 10 registers this vehicle-specific ID 17b as an ID of the communication partner, and identifies the communication partner based on the registered vehicle-specific ID 17b in the subsequent communication.

The security controller 10, which has established communication with the server device 5 with the registration of the vehicle-specific ID 17b, collects necessary information from the in-vehicle network by processing the program for transmitting information to the police, and transmits the collected information to the server device 5. At that time, the security controller 10 adds the vehicle-specific ID 17b registered in the server device 5 to the information to be transmitted, and transmits the information to the server device 5. The information that the security controller 10 can transmit to the server device 5 based on the processing of the program for transmitting information to the police is information whose access permission level is set to any of 1 to 3 in the access permission level table 17d of FIG. 4, that is, all the information available in the in-vehicle network.

By the processing of the program for transmitting information to the police, the security controller 10 transmits, for example, the position information and the user information of the vehicle 1 to the server device 5 of the police. The server device 5 obtains a vehicle-specific ID 17b added to, for example, a stolen car, a lost car, or the like, user information on this vehicle, and the like from a manufacturer or a dealer of the vehicle 1. The server device 5 determines whether or not communication between the stolen car, the lost car, or the like and the roadside communication apparatus 3 has been performed, based on the vehicle-specific ID 17b and the user information collected from various vehicles 1 and, if such communication has been performed, the server device 5 can identify the position of the vehicle 1 based on the position information transmitted from the vehicle 1.

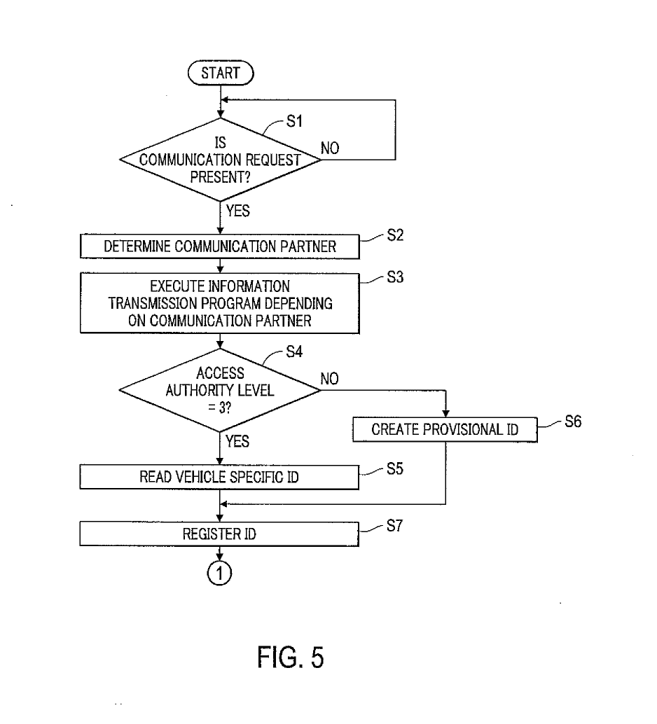

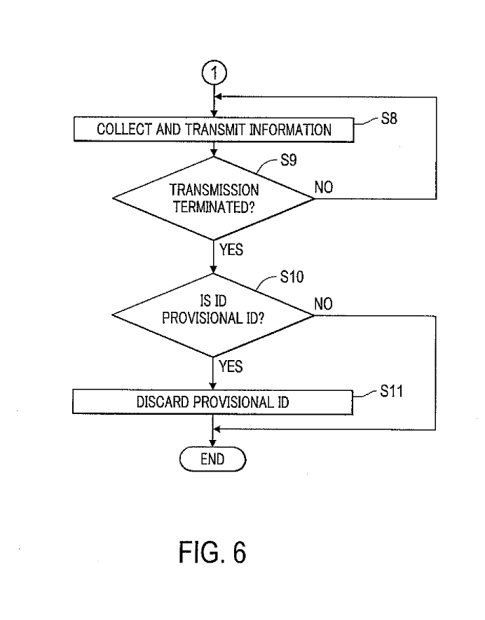

FIGS. 5 and 6 are flowcharts illustrating procedures of information transmission processing by the security controller 10. The CPU 11 of the security controller 10 determines whether or not a communication request from the roadside communication apparatus 3 has been received by the wireless communication unit 15 (step S1). If no communication request has been received (No, in step S1), the CPU 11 stands by until a communication request is received. If a communication request has been received (Yes, in step S1), the CPU 11 determines the communication partner based on the information added to the communication request (step S2), and executes an information transmission program in accordance with the communication partner (step S3).

The CPU 11 refers to the access authority level table 17c stored in the storage unit 17, and determines whether or not the access authority level of the information transmission program executed in step S3 is level 3 (step S4). If the access authority level is level 3 (Yes, in step S4), the CPU 11 reads the vehicle-specific ID 17b stored in the storage unit 17 (step 5). If the access authority level is not level 3, that is, the access authority level is level 1 or 2 (No, in step S4), the CPU 11 creates a provisional ID based on random numbers or the like (step S6). Subsequently, the CPU 11 transmits either the vehicle-specific ID 17b read in step S5 or the provisional ID created in step S6 to the server device 5, performs authentication processing or the like, and registers the ID for communication in the server device 5 (step S7).

Then, the CPU 11 collects information needed by the server device 5 by processing the information transmission program, and transmits the collected information to the server device 5 using the ID registered in step S7 (step S8). The CPU 11 determines whether or not any condition for terminating the information transmission is satisfied (step S9), and if the condition for terminating the information transmission is not satisfied (No, in step S9), the procedure returns to step S8, where the information collection and transmission are performed repeatedly. If the condition for terminating the information transmission is satisfied (Yes, in step S9), the CPU 11 determines whether or not the ID used for the information transmission to the server device 5 was the provisional ID (step S10). If the information transmission was performed using the provisional ID (Yes, in step S10), the CPU 11 discards this provisional ID (step S11), and the procedure ends. If the information transmission was not performed using the provisional ID, that is, the information transmission was performed using the vehicle-specific ID 17b (No, in step S10), the CPU 11 ends the procedure.

In the communication system having the above-described configuration, the security controller 10 selects either the vehicle-specific ID 17b stored in the storage unit 17 or the provisional ID created based on random numbers or the like, and performs communication with the server device 5 via the roadside communication apparatus 3 using the selected ID. By the security controller 10 selecting, according to the need, the ID for use in communication with the server device 5, it is possible to restrict transmission of information with which the vehicle 1 can be specified to the outside of the vehicle.

Furthermore, when the communication using the created provisional ID is terminated, the security controller 10 discards this provisional ID. If a need to communicate with the server device 5 occurs afterward, the security controller 10 creates a new provisional ID. Accordingly, a different provisional ID will be used each time the security controller 10 communicates with the server device 5.

Furthermore, the security controller 10 transmits information from the in-vehicle device 50 to the server device 5 by executing an information transmission processing program in the CPU 11. The security controller 10 stores in the storage unit 17 the access authority level table 17c in which access authority levels are set in association with respective information transmission programs, and determines which of the vehicle-specific ID 17b and the provisional ID is used to perform communication, depending on the access authority level of the information transmission program. For example, the provisional ID is used for communication with the server device 5 by an information transmission program having the low access authority level (level 1 or 2), and the vehicle-specific ID 17b is used for communication with the server device 5 by an information transmission program having the high access authority level (level 3). Accordingly, by appropriately setting an access authority level depending on, for example, the communication partner by an information transmission program, the security controller 10 can appropriately determine which of the IDs is used to perform communication.

Furthermore, the security controller 10 restricts information to be transmitted to the outside of the vehicle, depending on an access authority level of an information transmission program. That is, the security controller 10 has stored in the storage unit 17 the access permission levels of information available in the in-vehicle network, as an access permission level table 17d, and restricts information that an information transmission program transmits to the outside of the vehicle, depending on the access authority level of the information transmission program and the access permission level of the information. Accordingly, it is possible to prevent important information in the vehicle from leaking to the outside of the vehicle.

Note that although some embodiments have a configuration in which the gateway 30 is connected to the security controller 10 and a plurality of in-vehicle devices 50 are connected to the gateway 30, this configuration of the in-vehicle network is just an example and the present disclosure is not limited to this configuration. For example, a configuration is also possible in which the security controller 10 has the function of the gateway, and the plurality of in-vehicle devices 50 are connected to the security controller 10. Furthermore, a configuration is also possible in which any one of the in-vehicle devices 50 has the function of the security controller 10. It is also possible that a plurality of security controllers 10 are installed in the vehicle 1.

Furthermore, although the present disclosure provides traffic center servers and the police as examples of the server device 5 with which the security controller 10 communicates, these are merely examples, and the server device 5 may be a server that is used for any service. Furthermore, although the present embodiment has the configuration in which the security controller 10 and the server device 5 communicate with each other via the roadside communication apparatus 3, the present disclosure is not limited to this embodiment, and a configuration is also possible in which communication is performed via, for example, the public wireless Local Area Network (LAN), a mobile telephone network, or the like.

What is claimed is:

1. An in-vehicle relay apparatus for relaying communication between an in-vehicle device and a vehicle external communication device disposed outside of the vehicle, the in-vehicle relay apparatus comprising:
a vehicle internal communication unit configured to communicate with at least one in-vehicle device installed in a vehicle;
a vehicle external communication unit configured to communicate with the vehicle external communication device;
a communication processing unit configured to (1) add identification information to relay information to be transmitted to the vehicle external communication device, the identification information regarding a transmission source of the relay information by which the vehicle external communication device can determine the transmission source of the relay information, and to (2) transmit to the vehicle external communication device, using the vehicle external communication unit, the relay information to which the identification information is added;
an acquiring unit configured to acquire first information stored in a storage unit;
a creation unit configured to create second information that is different from the first information; and
a determination unit configured to determine which of the first information and the second information the communication processing unit is to use as the identification information,
wherein the communication processing unit is further configured to transmit the relay information to the vehicle external communication device using, as the identification information, either the first information or the second information depending on a result of the determination unit.

2. The in-vehicle relay apparatus according to claim 1, further comprising:
a discard determination unit configured to determine, after having communicated with the vehicle external communication device using the second information created by the creation unit, whether to discard the second information based on whether a predetermined condition is satisfied,
wherein, if the discard determination unit determines that the second information is to be discarded, the second information is discarded.

3. The in-vehicle relay apparatus according to claim 2, wherein the predetermined condition includes information: (i) that communication between the vehicle external communication device and the vehicle external communication unit is terminated, (ii) that communication between the vehicle external communication device and the vehicle external communication unit has not been performed for a predetermined period of time, (iii) that a predetermined period of time has elapsed since the creation unit created the second information, (iv) that a request is given from the vehicle external communication device, or (v) that a switch for starting a motor of the vehicle is switched to a predetermined state.

4. The in-vehicle relay apparatus according to claim 1, further comprising:
a program storage unit that stores at least one information transmission processing program that executes processing for transmitting, to the vehicle external communication device, information that the vehicle internal communication unit has received from the at least one in-vehicle device;
a processing unit configured to execute the information transmission processing program stored in the program storage unit; and
an access authority level storage unit that stores an access authority level for each information transmission processing program,
wherein the determination unit is configured to perform the determination based on the access authority level stored in the access authority level storage unit.

5. The in-vehicle relay apparatus according to claim 4,
wherein the determination unit is configured to:
determine that communication with the vehicle external communication device by a said information transmission processing program has a low access authority level is performed using the second information created by the creation unit, and
determine that communication with the vehicle external communication device by a said information transmission processing program has a high access authority level is performed using the first information.

6. The in-vehicle relay apparatus according to claim 4, wherein the access authority level is based on a transmission destination to which the information transmission processing program transmits information.

7. The in-vehicle relay apparatus according to claim 1, wherein the first information is information that is specific to the vehicle.

8. The in-vehicle relay apparatus according to claim 1, wherein the creation unit is configured to create the second information using a random number.

9. A communication system comprising:
at least one in-vehicle device installed in a vehicle;
a vehicle external communication device disposed outside of the vehicle; and
an in-vehicle relay apparatus that relays communication between the at least one in-vehicle device and the vehicle external communication device,
the in-vehicle relay apparatus comprising:
a vehicle internal communication unit that communicates with the at least one in-vehicle device;
a vehicle external communication unit that communicates with the vehicle external communication device;
a communication processing unit configured to (1) add identification information to relay information to be transmitted to the vehicle external communication device, the identification information regarding a transmission source of the relay information by which the vehicle external communication device can determine the transmission source of the relay information, and to (2) transmit to the vehicle external communication device, using the vehicle external communication unit the relay information to which the identification information is added;
an acquiring unit configured to acquire first information stored in a storage unit;
a creation unit configured to create second information that is different from the first information; and
a determination unit configured to determine which of the first information and the second information the communication processing unit is to use as the identification information,
wherein the communication processing unit is further configured to transmit the relay information to the vehicle external communication device using, as the identification information, either the first information or the second information depending on a result of the determination unit.

10. The in-vehicle relay apparatus according to claim 4,
wherein if the access authority level of a said information transmission processing program is lower than an access permission level, the in-vehicle relay apparatus does not permit transmission of the relay information by this said information transmission processing program.
